(19) United States
(12) Patent Application Publication
(10) Pub. No.: US 2020/0158912 A1
(43) Pub. Date: May 21, 2020

(54) GLASS-PLASTIC HYBRID LENS ASSEMBLY

(71) Applicant: JIANGXI LIANCHUANG ELECTRONIC CO., LTD., Nanchang (CN)

(72) Inventors: Zhuo Wang, Nanchang (CN); Hongbin Peng, Nanchang (CN); Yumin Bao, Nanchang (CN); Xuming Liu, Nanchang (CN); Jiyong Zeng, Nanchang (CN)

(21) Appl. No.: 16/629,270

(22) PCT Filed: Apr. 30, 2019
(86) PCT No.: PCT/CN2019/085182

§ 371 Date: Jan. 7, 2020

(30) Foreign Application Priority Data
May 22, 2018 (CN) 201810493960.4

(51) Int. Cl. G02B 1/04; G02B 5/20; G02B 1/11; G02B 1/14; G02B 13/18

(52) U.S. Cl. CPC G02B 1/041; G02B 5/208; G02B 13/18; G02B 1/14; G02B 1/11

(57) ABSTRACT

Provided in the present disclosure is a glass-plastic hybrid lens assembly. The glass-plastic hybrid lens assembly comprises a glass lens and at least one plastic lens from an object side to an image side of the glass-plastic hybrid lens assembly in turn; and an ultraviolet cutoff layer, in which the ultraviolet cutoff layer is disposed at a side of the plastic lens away from the image side, and the ultraviolet cutoff layer is disposed spaced from the plastic lens. The glass-plastic hybrid lens assembly is simple and easy to be realized; the ultraviolet cutoff layer can effectively absorb or reflect the ultraviolet irradiation on the glass-plastic hybrid lens assembly, thereby preventing subsequent plastic lenses from ultraviolet irradiation effectively and solving demoulding and yellowing phenomena of plastic lenses occurring under strong UV irradiation effectively, thus effectively improving the UV resistance and solar-irradiance resistance of the glass-plastic hybrid lens assembly. Further, the glass-plastic hybrid lens assembly can effectively achieve athermalization at a low cost by combining a glass lens with a plastic lens.

### CROSS-REFERENCE TO RELATED APPLICATIONS

This application is a US National Phase application based upon PCT Application No. PCT/CN2019/085182 filed with the National Intellectual Property Administration of P. R. China on Apr. 30, 2019, which claims priority to Chinese Patent Application No. 201810493960.4 filed May 22, 2018, the entire content of which are incorporated herein by reference.

### FIELD

The present disclosure relates to optical components, in particular to a glass-plastic hybrid lens assembly.

### BACKGROUND

Advanced driver assistance system (ADAS), incorporating various advanced sensor components and artificial intelligence, has developed into the focus of most attention in recent years. A typical ADAS comprises two parts, specifically peripheral sensor devices (such as a camera, laser radar, an ultrasonic detector and the like) and a central processor which processes the fused information of the sensor device and then gives forewarning. The peripheral sensor devices, such as lenses, with great advantages of cheapness and large information, have been widely applied in the ADAS by combining with the current artificial intelligence and machine learning.

For the existing lens design, achieving athermalization within a broad temperature range (such as −40° C. to +85° C. or even +105° C.) is challenging. A lens assembly having glass lens and plastic lens is usually used so as to realize athermalization. However, the plastic lens has a severe problem of poor thermal stability in high and low temperature environment and poor ultraviolet (UV) resistance. Specifically, a plastic material has a thermal expansion coefficient about ten times larger than that of a glass material, resulting in poor thermal stability; the anti-reflection film and the black light-absorbing ink coated on the surface of the plastic lens may occur demoulding under high temperature, high humidity and temperature cycles, thus affecting the imaging quality significantly; and the plastic lenses or even plastic lens barrels will appear demoulding and yellowing phenomena under strong UV irradiation. Such potential problems have severely affected the wide application of the lens assembly having the glass lens and the plastic lens.

### SUMMARY

Embodiments of the present disclosure seek to solve at least one of the problems existing in the related art. Accordingly, an object of the present disclosure is to provide a glass-plastic hybrid lens assembly with excellent thermal stability and ultraviolet resistance. The glass-plastic hybrid lens assembly provided has great imaging quality and a long service life.

In an aspect of the present disclosure, provided in embodiments is a glass-plastic hybrid lens assembly. According to some embodiments of the present disclosure, the glass-plastic hybrid lens assembly comprises a glass lens and at least one plastic lens from an object side to an image side of the glass-plastic hybrid lens assembly in turn, and an ultraviolet cutoff layer, wherein the ultraviolet cutoff layer is disposed at a side of the plastic lens away from the image side, and the ultraviolet cutoff layer is disposed spaced from the plastic lens. The glass-plastic hybrid lens assembly of the present disclosure is simple and easy to be realized. The ultraviolet cutoff layer can effectively absorb or reflect the ultraviolet irradiation on the glass-plastic hybrid lens assembly, thereby preventing subsequent plastic lenses from ultraviolet irradiation effectively and solving demoulding and yellowing phenomena of plastic lenses occurring under strong UV irradiation effectively, thus effectively improving the UV resistance and solar-irradiance resistance of the glass-plastic hybrid lens assembly. Further, the glass-plastic hybrid lens assembly can effectively achieve athermalization at a low cost by combining the glass lens with the plastic lens.

According to some embodiments of the present disclosure, the glass lens is made of a glass material capable of absorbing ultraviolet ray, and the glass lens is multiplexed into the ultraviolet cutoff layer. Therefore, the glass lens simultaneously exhibits functions of light transmission and ultraviolet absorption, thus lowering the preparation cost.

According to some embodiments of the present disclosure, the ultraviolet cutoff layer is disposed at a first surface of the glass lens facing the object side or disposed at a second surface of the glass lens facing the image side. Therefore, the structure is simple and easy to be realized; the ultraviolet cutoff layer exhibits strong adhesion when coated on the surface of the glass lens and can effectively absorb the ultraviolet lights, thus avoiding ultraviolet irradiation to subsequent plastic lenses, with a long service life.

According to some embodiments of the present disclosure, the glass-plastic hybrid lens assembly further comprises an anti-reflection firm, wherein the anti-reflection firm is disposed at a first surface of the glass lens facing the object side or disposed at a second surface of the glass lens facing the image side, thereby increasing the transmittance of visible lights, improving the sharpness and contrast of lens imaging and obtaining high imaging quality.

According to some embodiments of the present disclosure, one of the ultraviolet cutoff layer and the anti-reflection film is disposed at the first surface of the glass lens facing the object side, and the other of the ultraviolet cutoff layer and the anti-reflection film is disposed at the second surface of the glass lens facing the image side. Therefore, the preparation process is convenient and at a low cost. The ultraviolet cutoff layer and the anti-reflection film each can fully exert their respective functions without mutual interference. According to an embodiment of the present disclosure, the anti-reflection film has a thickness of 100 nm to 800 nm. Therefore, the transmittance of visible lights can be greatly improved and the lens imaging exhibits better sharpness and contrast effects. According to an embodiment of the present disclosure, the ultraviolet cutoff layer is selected from an ultraviolet cutoff film and an ultraviolet-infrared cutoff film. Therefore, the ultraviolet cutoff film or the ultraviolet-infrared cutoff film has a better effect on reflecting ultraviolet rays. The ultraviolet-infrared cutoff film can also effectively reflect infrared rays, thus improving the control to stray lights and effectively avoiding the generation of halos, with improved imaging quality and greater use performance.

According to some embodiments of the present disclosure, the ultraviolet cutoff film or the ultraviolet-infrared cutoff film has an anti-reflection effect on visible-lights. Therefore, the ultraviolet cutoff film or the ultraviolet-infrared cutoff film can not only respectively prevent ultraviolet radiation or infrared radiation from entering the glass-plastic hybrid lens assembly, but also effectively increase the transmittance of visible lights (400 nm to 700 nm), thereby improving the imaging quality. In the firm-system design, three options can be selected. Specifically, in the first option, two surfaces of the glass lens are respectively coated with the ultraviolet cutoff film and the anti-reflection film, such that one surface with the ultraviolet cutoff film can exhibit effects of ultraviolet cutoff and visible-light anti-reflection, and the other surface with the anti-reflection film can exhibit visible-light anti-reflection effect; in the second option, two surfaces of the glass lens are respectively coated with the ultraviolet-infrared cutoff film and the anti-reflection film, such that one surface with the ultraviolet-infrared cutoff film can exhibit effects of ultraviolet and infrared cutoff and visible-light anti-reflection, and the other surface with the anti-reflection film can exhibit visible-light anti-reflection effect; and in the third option, two surfaces of the glass lens are respectively coated with the ultraviolet cutoff film and the infrared cutoff film, such that one surface with the ultraviolet cutoff film can exhibit effects of ultraviolet cutoff and visible-light anti-reflection, and the other surface with the infrared cutoff film can exhibit effects of infrared cutoff and visible-light anti-reflection. The specific arrangement of the two surfaces of the glass lens is not limited. Any of the anti-reflection film, the ultraviolet cutoff film and the ultraviolet-infrared cutoff film facing the object side is within the scope of the present disclosure. According to an embodiment of the present disclosure, the ultraviolet cutoff film has a thickness of 1000 nm to 5000 nm and the ultraviolet-infrared cutoff film has a thickness of 3000 nm to 9000 nm, thus the ultraviolet cutoff film and the ultraviolet-infrared cutoff film have a better effect on reflecting ultraviolet rays or infrared rays, with greater use performance. According to an embodiment of the present disclosure, the glass lens has an average thickness not less than 0.8 mm and has a light absorption at a wavelength of 360 nm not less than 20%, thus the glass lens can have ultraviolet absorption effect even at a low average thickness, thereby protecting subsequent plastic lenses from ultraviolet irradiation.

According to an embodiment of the present disclosure, the material forming the glass lens is flint glass. Therefore, the flint glass having a high refractive index can absorb most of the ultraviolet rays and greatly reduces the transmittance of ultraviolet rays, thereby protecting subsequent plastic lenses from ultraviolet irradiation and improving UV resistance, with a better protection effect.

According to an embodiment of the present disclosure, the glass lens is capable of absorbing lights at a wavelength between 400 nm and 500 nm. Therefore, the glass lens can absorb part of blue lights, thereby effectively avoiding blue-light irradiation to subsequent plastic lenses, effectively prolonging the service life of the glass-plastic hybrid lens assembly. Further, use of the glass lens as described above is useful for achromatization, thus simplifying the entire structure of the glass-plastic hybrid lens assembly at a reduced cost.

According to an embodiment of the present disclosure, the glass lens is a spherical glass lens or a flat glass lens. Therefore, the spherical glass lens costs lower than a molded glass lens and can be processed in an easier way, obtaining excellent thermal stability; and the flat glass lens can effectively protect the glass-plastic hybrid lens assembly. Further, coating a firm on the surface of the spherical glass lens can be easily realized via a simple process under reduced production difficulties.

The glass lens is not limited to a spherical or flat glass lens within the cost range. Further, the aspheric glass lens can also improve imaging quality, which can be used within the cost range.

According to an embodiment of the present disclosure, the glass-plastic hybrid lens assembly further comprises a waterproof film, an anti-scratch film or a waterproof-anti-scratch film. The waterproof film, the anti-scratch film or the waterproof-anti-scratch film is disposed at a side of the glass lens close to the object side and is disposed close to an object. Therefore, effects of water-proofing, oil-proofing, scratch-proofing or anti-static can be effectively achieved, avoiding damage of the glass-plastic hybrid lens assembly under a high humidity working environment, with greatly increased service life.

According to an embodiment of the present disclosure, the glass-plastic hybrid lens assembly further comprises a lens barrel. The glass lens, the plastic lens and the ultraviolet cutoff layer are all disposed in the lens barrel, and at least a portion of the outer surface of the lens barrel is provided with an ultraviolet reflective film or an ultraviolet absorbing film. Therefore, the ultraviolet irradiation to the lens barrel can be effectively avoided, thus effectively solving the problems of yellowing and demolding of lens barrel occurring under strong ultraviolet irradiation, with a prolonged service life for the lens barrel.

According to an embodiment of the present disclosure, the glass-plastic hybrid lens assembly as described above is a vehicle-mounted lens. Therefore, the vehicle-mounted lens as described above can work efficiently within a wide temperature range, achieve strong athermalization effect, and have excellent UV resistance and great use performance. Meanwhile, the vehicle-mounted lens as described above is also simple and costs lower, which can be widely used in the vehicle-mounted system.

In another aspect of the present disclosure, provided in embodiments of the present disclosure is a vehicle. According to an embodiment of the present disclosure, the vehicle comprises the glass-plastic hybrid lens assembly as described above. The present inventors have found that the glass-plastic hybrid lens assembly in the vehicle has a long service life and displays clear images and excellent UV resistance, which can be operated within a wide temperature range. Meanwhile, the glass-plastic hybrid lens assembly costs lower, which can be widely used in the vehicle-mounted system.

### BRIEF DESCRIPTION OF THE DRAWINGS

FIG. 1 is a schematic diagram showing the structure of a glass-plastic hybrid lens assembly according to an embodiment of the present disclosure.

FIG. 2 is a schematic diagram showing the structure of a glass-plastic hybrid lens assembly according to another embodiment of the present disclosure.

FIG. 3 is a graph showing the light transmission at a wavelength between 270 nm and 700 nm of a glass-plastic hybrid lens assembly coated with an ultraviolet cutoff film on the surface facing an object side and an anti-reflection film on the surface facing an image side according to Example 1.

FIG. 4 is a graph showing the light reflectivity at a wavelength between 380 nm and 780 nm of a glass-plastic hybrid lens assembly coated with an ultraviolet cutoff film on the surface facing an object side and an anti-reflection film on the surface facing an image side according to Example 1.

FIG. 5 is a graph showing the light transmission at a wavelength between 300 nm and 700 nm of a glass-plastic hybrid lens assembly coated with an ultraviolet-infrared cut film on the surface facing an object side and an anti-reflection film on the surface facing an image side according to Example 2.

FIG. 6 is a graph showing the light transmission at a wavelength between 300 nm and 1100 nm of a glass-plastic hybrid lens assembly coated with an ultraviolet-infrared cut film on the surface facing an object side and an anti-reflection film on the surface facing an image side according to Example 2.

FIG. 7 is a schematic diagram showing the structure of a glass-plastic hybrid lens assembly according to another embodiment of the present disclosure.

FIG. 8 is a schematic diagram showing the structure of a glass-plastic hybrid lens assembly according to another embodiment of the present disclosure.

FIG. 9 is a graph showing the light transmission at a wavelength between 250 nm and 1100 nm of a glass-plastic hybrid lens assembly coated with an ultraviolet-infrared cut film on the surface facing an object side and an anti-reflection film on the surface facing an image side according to Example 9.

### DETAILED DESCRIPTION

Embodiments of the present disclosure are described in detail below. The embodiments described below are illustrative only and are not to be construed as limiting the present disclosure. The specific techniques or conditions which are not indicated in examples are carried out according to the techniques or conditions described in the literature in the art or according to the product specification. The used reagents or instruments which are not indicated by the manufacturer are all conventional products that can be obtained commercially.

Most glass lenses have a refractive index which increases with temperature, that is, a positive dn/dT representing the change rate of refractive index of a material with temperature, thus the optical back focal of a glass lens is reduced and the mechanical back focus of the glass lens is increased due to the expansion of a lens barrel at an increased temperature in a normal situation, resulting in a very severe focus drift in high and low temperature environment, thereby deteriorating imaging quality greatly. For optical compensation, a common method is to combine the glass lens with a plastic lens made of a plastic material having a negative dn/dT, so as to compensate the change of the optical back focal and the mechanical back focus, thereby achieving the purpose of athermalization at a low cost. However, the plastic lens has several prominent problems, such as poor thermal stability in high and low temperature environment and poor UV resistance, which affects the imaging quality severely. For solving the above technical problems, the present inventors, after in-depth research, have found that it is able to avoid the damage of plastic lenses effectively by allowing the glass lens and the plastic lens disposed from an object side to an image side in turn, and allowing an ultraviolet cutoff layer disposed at a side of the plastic lens away from the image side to absorb ultraviolet rays, thereby preventing subsequent plastic lenses from ultraviolet irradiation.

In view of these, in one aspect of the present disclosure, provided in embodiments of the present disclosure is a glass-plastic hybrid lens assembly. According to an embodiment of the present disclosure, the glass-plastic hybrid lens assembly comprises a glass lens and at least one plastic lens from an object side to an image side of the glass-plastic hybrid lens assembly in turn, and an ultraviolet cutoff layer, in which the ultraviolet cutoff layer is disposed at a side of the plastic lens away from the image side, and the ultraviolet cutoff layer is disposed spaced from the plastic lens. It is found by the present inventors that the glass-plastic hybrid lens assembly as described above is simple and easy to be realized; the ultraviolet cutoff layer can effectively absorb or reflect the ultraviolet irradiation on the glass-plastic hybrid lens assembly, preventing subsequent plastic lenses from ultraviolet irradiation effectively and solving demoulding and yellowing phenomena of plastic lenses occurring under strong UV irradiation effectively, thereby effectively improving the UV resistance and solar-irradiance resistance of the glass-plastic hybrid lens assembly. Further, the glass-plastic hybrid lens assembly can effectively achieve athermalization by combining a glass lens with a plastic lens at a low cost.

It should be noted that the ultraviolet cutoff layer as described above can absorb or reflect ultraviolet rays, thereby effectively preventing ultraviolet rays from passing through the ultraviolet cutoff layer. According to the wavelength, ultraviolet lights can be classified into near ultraviolet (UVA) (wavelength ranging from 315 nm to 400 nm), far ultraviolet (UVB) (wavelength ranging from 280 nm to 315 nm) and ultrashort ultraviolet (UVC) (wavelength ranging from 100 nm to 280 nm). Among them, UVC has been absorbed in the ozone layer, thus the ultraviolet cutoff of the glass-plastic hybrid lens assembly according to the present disclosure aims at the reflection or absorption of UVA or UVB.

According to an embodiment of the present disclosure, the ultraviolet cutoff layer is disposed at a first surface of the glass lens facing the object side or disposed at a second surface of the glass lens facing the image side. Therefore, the structure is simple and easy to be realized; the ultraviolet cutoff layer exhibits strong adhesion when coated on the surface of the glass lens and can effectively absorb the ultraviolet lights, avoiding ultraviolet irradiation to the subsequent plastic lenses, with a long service life. According to an embodiment of the present disclosure, the ultraviolet cutoff layer is selected from an ultraviolet cutoff film and an ultraviolet-infrared cutoff film. Therefore, the ultraviolet cutoff film or the ultraviolet-infrared cutoff film has a better effect on reflecting ultraviolet rays. The ultraviolet-infrared cutoff film can also effectively reflect infrared rays, improving the control to stray lights, and effectively avoiding the generation of halos, with greater use performance. According to an embodiment of the present disclosure, the ultraviolet cutoff film highly cuts off waveband ranging from 280 nm to 400 nm, and is highly transparent to waveband ranging from 410 nm to 1100 nm; and the ultraviolet-infrared cutoff film highly cuts off waveband ranging from 280 nm to 400 nm and waveband ranging from 700 nm to 1100 nm, and is highly transparent to waveband ranging from 410 nm to 700 nm. It should be noted that the cutoff as described above means that the ultraviolet light is reflected by the ultraviolet cutoff film or the ultraviolet-infrared cutoff film. According to an embodiment of the present disclosure, the ultraviolet cutoff film or the ultraviolet-infrared cutoff film can be formed via vapor deposition and the like.

According to an embodiment of the present disclosure, the ultraviolet cutoff film has a thickness of 1000 nm to 5000 nm, for example the ultraviolet cutoff film may have a thickness of 1000 nm, 1500 nm, 2000 nm, 2500 nm, 2800 nm, 3100 nm, 3400 nm, 3700 nm, 4000 nm, 4300 nm, 4600 nm, 4800 nm, 5000 nm and the like; and the ultraviolet-infrared cutoff film has a thickness of 3000 nm to 9000 nm, for example the ultraviolet-infrared cutoff film may have a thickness of 3000 nm, 3500 nm, 4000 nm, 4500 nm, 5000 nm, 5500 nm, 6000 nm, 6500 nm, 7000 nm, 7500 nm, 8000 nm, 8500 nm, 9000 nm and the like. Therefore, the ultraviolet cutoff film and the ultraviolet-infrared cutoff film have a better effect on reflecting ultraviolet rays or infrared rays, with greater use performance. According to an embodiment of the present disclosure, materials forming the ultraviolet cutoff film and the ultraviolet-infrared cutoff film are a conventional material, which can be flexibly selected according to actual needs.

According to an embodiment of the present disclosure, the ultraviolet cutoff film or the ultraviolet-infrared cutoff film has an anti-reflection effect on visible lights in order to increase the transmittance of visible lights. Therefore, the ultraviolet cutoff film can not only prevent ultraviolet radiation from entering the glass-plastic hybrid lens assembly, but also effectively increase the transmittance of visible lights, thereby improving the imaging quality and prolonging the service life of the glass-plastic hybrid lens assembly. It should be noted, the anti-reflection effect on visible lights means that the ultraviolet cutoff film or the ultraviolet-infrared cutoff film has an average light transmittance at a wavelength of 450 nm to 650 nm of more than 90%.

According to an embodiment of the present disclosure, the glass-plastic hybrid lens assembly may further include an anti-reflection film in order to further reduce reflection of visible lights. The anti-reflection film is disposed at a first surface of the glass lens facing the object side or disposed at a second surface of the glass lens facing the image side, thereby increasing the transmittance of visible lights, improving the sharpness and contrast of lens imaging and obtaining high imaging quality. In some preferred embodiments of the present disclosure, the anti-reflection film is disposed at the surface of the glass lens facing the object side. In some particular embodiments of the present disclosure, one of the ultraviolet cutoff layer (such as, an ultraviolet cutoff film, an ultraviolet-infrared cutoff film and the like) and the anti-reflection film is disposed at the first surface of the glass lens facing the object side, and the other of the ultraviolet cutoff layer (such as, an ultraviolet cutoff film, an ultraviolet-infrared cutoff film and the like) and the anti-reflection film is disposed at the second surface of the glass lens facing the image side. It should be noted, the glass lens as described in the above embodiments may or may not have a function of absorbing ultraviolet rays. Therefore, the preparation process is convenient and at a low cost. The ultraviolet cutoff layer and the anti-reflection film each can fully exert their respective functions without mutual interference, thus increasing the transmittance of visible lights, improving the sharpness and contrast of lens imaging and obtaining high imaging quality. According to an embodiment of the present disclosure, the anti-reflection film may be formed via vapor deposition and the like.

According to an embodiment of the present disclosure, the anti-reflection film has a thickness of 100 nm to 800 nm, for example the anti-reflection film may have a thickness of 100 nm, 150 nm, 200 nm, 250 nm, 300 nm, 350 nm, 400 nm, 450 nm, 500 nm, 550 nm, 600 nm, 650 nm, 700 nm, 750 nm, 800 nm and the like. Therefore, the transmittance of visible lights can be greatly improved and the lens imaging exhibits better sharpness and contrast effects.

In some particular embodiments of the present disclosure, the glass-plastic hybrid lens assembly includes a glass lens and at least one plastic lens from an object side to an image side of the glass-plastic hybrid lens assembly in turn, an ultraviolet cutoff layer and an anti-reflection film, in which the ultraviolet cutoff layer and the anti-reflection film are respectively disposed at two corresponding surfaces of the glass lens, and the glass lens may or may not have a function of cutting ultraviolet rays. Therefore, the glass-plastic hybrid lens assembly is simple, easy to be realized and prepared at a low cost. The glass-plastic hybrid lens assembly also exhibits stronger ultraviolet cutoff effect, thereby preventing subsequent plastic lenses from ultraviolet irradiation effectively and avoiding demoulding or yellowing of plastic lenses, with a long service life. Further, the ultraviolet cutoff layer and the anti-reflection film each can fully exert their respective functions without mutual interference.

In some embodiments of the present disclosure, the glass lens is made of a glass material capable of absorbing ultraviolet rays, and the glass lens is multiplexed into the ultraviolet cutoff layer. Therefore, the glass lens simultaneously exhibits functions of light transmission and ultraviolet absorption, thus lowering the preparation cost, solving the glare problem occurring under the sunlight for the obtained glass-plastic hybrid lens assembly, and improving the imaging quality. It should be noted, the glass lens multiplexed into the ultraviolet cutoff layer means that the glass lens have functions of both lens imaging and absorbing ultraviolet rays as well as preventing ultraviolet rays from passing through the glass lens. Therefore, it is advantageous in the above embodiments to simplify structure and reduce costs.

According to an embodiment of the present disclosure, the light transmittance of a glass material absorbing ultraviolet rays at waveband of 280 nm to 400 nm is indicated as T_{L}, and the light transmittance of a glass material absorbing ultraviolet rays at waveband of 400 nm to 2400 nm is indicated as T_{H}. For a good ultraviolet absorption effect, T_{L} and T_{H} need satisfy the following requirement: T_{L}<15%; and T_{H}>90%. According to an embodiment of the present disclosure, the material forming the glass lens may be flint glass in order to meet the requirements of absorbing ultraviolet rays as described above. The flint glass exhibits low light transmittance for the lights within UVA and UVB spectrums, which can protect the subsequent plastic lenses from ultraviolet irradiation, with strong protection effect, thereby improving UV resistance and use performance of the glass-plastic hybrid lens assembly. According to an embodiment of the present disclosure, when multiplexed into the ultraviolet cutoff layer, the glass lens may further include an anti-reflection film in order to increase transmittance of visible lights. The anti-reflection firm is disposed at a first surface of the glass lens facing the object side or disposed at a second surface of the glass lens facing the image side. Therefore, the disposed anti-reflection film is capable of increasing the transmittance of visible lights, improving the sharpness and contrast of lens imaging and improving the imaging quality of the glass-plastic hybrid lens assembly obtained.

According to an embodiment of the present disclosure, the glass lens, in a yellow color, can also absorb lights at wavelength of 400 nm to 500 nm. Such a glass lens can be made of a material of H-ZF88, D-ZF93 and the like. Therefore, the glass lens can absorb part of blue lights, effectively avoiding the irradiation of blue lights to subsequent plastic lenses, thereby effectively prolonging the service life of the glass-plastic hybrid lens assembly. Further, use of the glass lens as described above is useful for achromatization, thus simplifying the entire structure of the glass-plastic hybrid lens assembly at a reduced cost.

According to an embodiment of the present disclosure, the glass lens has an average thickness not less than 0.8 mm and has a light absorption at a wavelength of 360 nm not less than 20%. Thus, the glass lens can have ultraviolet absorption effect even at a low average thickness, thereby protecting subsequent plastic lenses from ultraviolet irradiation. It should be noted, the average thickness of a glass lens refers to the average thickness of section of the glass lens.

According to an embodiment of the present disclosure, the glass lens is a spherical glass lens or a flat glass lens. Therefore, the spherical glass lens exhibits small thermal expansion and strong thermal stability, which is easy to be processed and can be prepared by a simple process at a low cost. The flat glass lens can effectively protect the glass-plastic hybrid lens assembly. Further, coating a firm on the surface of the spherical glass lens can be easily realized via a simple process under reduced production difficulties.

According to an embodiment of the present disclosure, the material forming the plastic lens is a conventional material. In order to achieve athermalization, the at least one plastic lens may be disposed at intervals or adjacently, which can be set according to specific conditions in actual use. According to an embodiment of the present disclosure, in order to achieve athermalization, the material and shape of the glass lens and the plastic lens should be adjusted to achieve a reasonable focal-power combination, such that the glass lens and the plastic lens can cooperate with each other under a large temperature change, that is, the refractive index changes of the glass lens and the plastic lens can be compensated by adjusting the material and shape of the glass lens and the plastic lens because the glass lens and the plastic lens respectively have a positively changed refractive index and a negatively changed refractive index with the increase of temperature, thus compensating the changes of optical back focal and mechanical back focus, avoiding focus drift, and improving imaging quality of the glass-plastic hybrid lens assembly.

It should be noted, only one glass lens included in the glass-plastic hybrid lens assembly is illustrated in the above embodiments, which cannot be construed as limiting the present disclosure. During the actual production or practical use, in order to achieve better athermalization, the glass-plastic hybrid lens assembly can further comprise at least one glass material lens at a side of the glass lens away from the object side, in which the glass material lens can be a spherical glass lens.

According to an embodiment of the present disclosure, for a better outdoor adaptability, the glass-plastic hybrid lens assembly further comprises a waterproof film, an antiscratch film or a waterproof-antiscratch film. The waterproof film, the antiscratch film or the waterproof-antiscratch film is disposed at a side of the glass lens close to the object side and is disposed close to an object. Therefore, effects of water-proofing, oil-proofing, scratch-proofing or anti-static can be effectively achieved, avoiding damage of the glass-plastic hybrid lens assembly under a high humidity working environment, with greatly increased service life.

It should be noted, the waterproof film, the antiscratch film or the waterproof-antiscratch film disposed close to an object means the waterproof film, the antiscratch film or the waterproof-antiscratch film is disposed at the outermost side of the glass lens close to an object in specific applications. According to an embodiment of the present disclosure, the material forming the waterproof film, the antiscratch film or the waterproof-antiscratch film is a conventional material, and the thickness of the waterproof film, the antiscratch film or the waterproof-antiscratch film can be flexibly selected according to actual needs, which will not be described in details.

According to an embodiment of the present disclosure, the glass-plastic hybrid lens assembly further comprises a lens barrel. The glass lens, the plastic lens, and the ultraviolet cutoff layer are all disposed in the lens barrel. At least a portion of the outer surface of the lens barrel is provided with an ultraviolet reflective film or an ultraviolet absorbing film. Therefore, the ultraviolet irradiation to the lens barrel can be effectively avoided, thus effectively solving the problems of yellowing and demolding of lens barrel occurring under strong ultraviolet irradiation, with prolonged service life for the lens barrel. It should be noted, the glass lens is disposed at the side of the plastic lens close to the object side. According to an embodiment of the present disclosure, the material forming the ultraviolet reflective film or the ultraviolet absorbing film is a conventional material, which will not be described in details. The ultraviolet reflective film or the ultraviolet absorbing film can have a thickness of 1000 nm to 5000 nm, and the material forming the lens barrel may be plastic and the like.

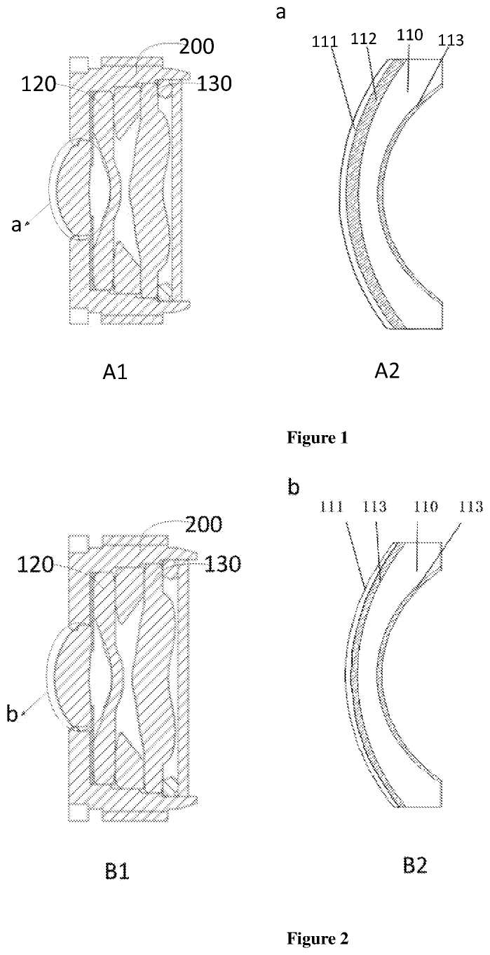

In some particular embodiments of the present disclosure, referring to FIG. 1, in which Figure A1 shows a front view of the glass-plastic hybrid lens assembly and Figure A2 shows a partial enlarged view at position a in Figure A1, the glass-plastic hybrid lens assembly comprises a lens barrel 200; a glass lens 110, a first plastic lens 120 and a second plastic lens 130 from an object side to an image side of the glass-plastic hybrid lens assembly in turn, and the glass lens 110, the first plastic lens 120 and the second plastic lens 130 are all disposed in the lens barrel 200; an anti-reflection film 113, disposed at a surface of the glass lens 110 away from the object side; an ultraviolet cutoff film 112, disposed at a surface of the glass lens 110 close to the object side; and a waterproof film 111, disposed at a surface of the ultraviolet cutoff film 112 close to the object side. In another particular embodiment of the present disclosure, referring to FIG. 2, in which Figure B1 shows a front view of the glass-plastic hybrid lens assembly and Figure B2 shows a partial enlarged view at position b in Figure B1, the glass-plastic hybrid lens assembly comprises a lens barrel 200; a glass lens 110, a first plastic lens 120 and a second plastic lens 130 from an object side to an image side of the glass-plastic hybrid lens assembly in turn, in which the glass lens 110, the first plastic lens 120 and the second plastic lens 130 are all disposed in the lens barrel 200, and the glass lens 110 is made of a glass material capable of absorbing ultraviolet rays; an anti-reflection film 113, disposed at a first surface of the glass lens 110 close to the object side and disposed at a second surface of the glass lens 110 away from the object side respectively; and a waterproof film 111, disposed at the surface of the glass lens 110 close to the object side. The glass-plastic hybrid lens assembly as described in the above embodiments is simple, easy to be realized, has strong thermal stability and UV resistance, and a long service life.

According to an embodiment of the present disclosure, the glass-plastic hybrid lens assembly as described above may further comprise a conventional structure, such as a diaphragm, a filter, a flat glass and the like, which will not be described in detail.

According to an embodiment of the present disclosure, the glass-plastic hybrid lens assembly as described above is a vehicle-mounted lens. Therefore, the vehicle-mounted lens as described above can work outdoors efficiently, and has improved athermalization and excellent UV resistance, as well as great use performance. The vehicle-mounted lens as described above is also simple and prepared at a low cost, which can be widely used in the vehicle-mounted system.

In another aspect of the present disclosure, provided in embodiments of the present disclosure is a vehicle. According to an embodiment of the present disclosure, the vehicle comprises the glass-plastic hybrid lens assembly as described above. The present inventors have found that the glass-plastic hybrid lens assembly in the vehicle has a long service life and displays clear images and excellent UV resistance, which can be operated within a wide temperature range, for example from −40° C. to 105° C. Meanwhile, the glass-plastic hybrid lens assembly in the vehicle is prepared at a low cost, which can be widely used in the vehicle-mounted system.

It should be noted, the installation position of the glass-plastic hybrid lens assembly in the vehicle is same as the conventional installation position, which will not be described in details. Apart from the glass-plastic hybrid lens assembly as described above, the vehicle further comprises those elements equipped in a conventional vehicle, such as tires, a vehicle body, an engine and the like, which will not be described in details.

According to the embodiments of the present disclosure, the glass-plastic hybrid lens assembly of the present disclosure can effectively absorb or reflect ultraviolet rays in lights, reduce the damage of ultraviolet rays to subsequent plastic lenses and improve the service life, thermal stability and UV resistance of the glass-plastic hybrid lens assembly by allowing arrangement of an ultraviolet cutoff layer at the side of the plastic lens away from the image side, compared to existing lens assembly with the glass lens and the plastic lens which shows easy damage of lens barrel or plastic lens under ultraviolet irradiation, poor thermal stability and a decreased imaging quality. Further, coating an ultraviolet reflective film on the outer surface of the lens barrel can effectively solve problems of yellowing and demoulding of lens barrel occurring under strong ultraviolet irradiation, thus improving the UV resistance and solar-radiation resistance of the entire lens.

### EXAMPLES

### Example 1

The specific structure of the glass-plastic hybrid lens assembly in this example can be referred to FIG. 1. The glass-plastic hybrid lens assembly comprises a lens barrel 200, on which out surface is coated with an ultraviolet reflective film having a thickness of 1000 nm to 5000 nm; a glass lens 110, a first plastic lens 120 and a second plastic lens 130 from an object side to an image side of the glass-plastic hybrid lens assembly in turn, in which the glass lens 110, the first plastic lens 120 and the second plastic lens 130 are disposed in the lens barrel 200 and the glass lens 110 is a spherical glass lens; an anti-reflection film 113, disposed at the surface of the glass lens 110 close to the image side and having a thickness of 324 nm; an ultraviolet cutoff film 112, disposed at the surface of the glass lens 110 close to the object side and having a thickness of 1259 nm; and a waterproof film 111, disposed at the surface of the ultraviolet cutoff film 112 close to the object side.

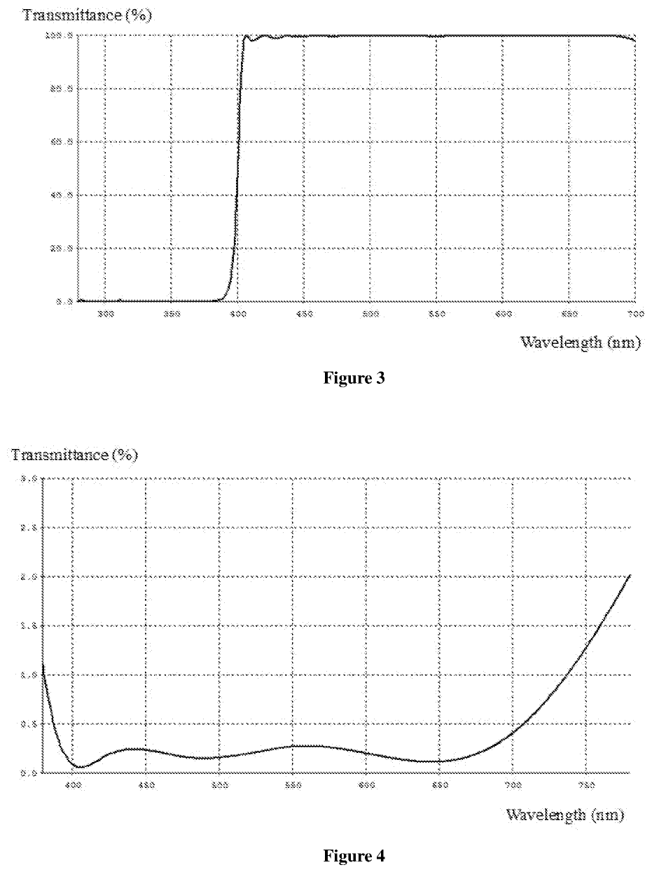

As shown in the light transmittance curve of FIG. 3, the glass-plastic hybrid lens assembly provided in this example has a light transmittance at visible-light band of 400 nm to 700 nm of 96% above, and has a light transmittance at ultraviolet band of 280 nm to 400 nm of 0.5% below. As shown in the reflectance curve of FIG. 4, the glass-plastic hybrid lens assembly provided in this example has a reflectivity to visible lights of less than 0.3%.

The glass-plastic hybrid lens assembly provided in this example can effectively reduce cost and has excellent thermal stability due to the reasonable combination of the glass lens and the plastic lens; is capable of effectively avoiding the ultraviolet irradiation to subsequent plastic lenses due to the ultraviolet cutoff film coated at the surface of the glass lens, thereby effectively solving the demoulding and yellowing phenomena of plastic lens even plastic lens barrel occurring under strong ultraviolet irradiation, such that the glass-plastic hybrid lens assembly has excellent UV resistance. Further, spherical glass lenses are used in the present disclosure, with features not only small thermal expansion and good thermal stability owned by itself but also realizing athermalization in a high and low temperature environment, coating film on which surface also exhibits good effect. Furthermore, the waterproof film can protect the glass-plastic hybrid lens assembly, by which the service life of the lens assembly is greatly increased.

### Example 2

The glass-plastic hybrid lens assembly in this example is substantially same as that in Example 1, except that an ultraviolet-infrared cutoff film (UV-IR Cut) having a thickness of 5490 nm is disposed at the surface of the glass lens close to the image side, and an anti-reflection film having a thickness of 324 nm is disposed at the surface of the glass lens close to the object side.

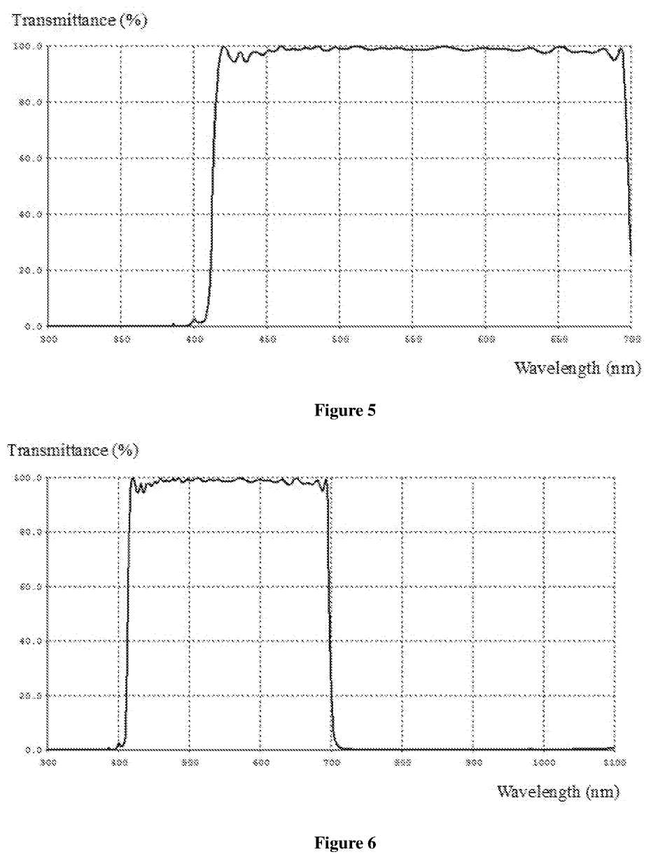

Coating the ultraviolet-infrared cutoff film at the surface of the glass lens close to the image side can not only absorb ultraviolet rays but also improve the control to stray lights, with cut-off at the near-infrared light. As shown in the transmittance curves of FIG. 5 and FIG. 6, the glass-plastic hybrid lens assembly provided in this example has light transmittance at visible-light waveband from 410 nm to 700 nm of 96% above, has light transmittance at ultraviolet waveband from 300 nm to 410 nm of 0.5% below, and shows nearly transmittance cut-off to the near-infrared light.

The glass-plastic hybrid lens assembly provided in this example can effectively reduce the cost and has good thermal stability due to the reasonable combination of the glass lens and the plastic lens. The ultraviolet-infrared cutoff film coated at the surface of the glass lens can effectively block the ultraviolet irradiation to subsequent plastic lenses, thereby effectively solving the demoulding and yellowing phenomena of plastic lens even plastic lens barrel occurring under strong ultraviolet irradiation, thus the glass-plastic hybrid lens assembly exhibits excellent ultraviolet resistance.

### Example 3

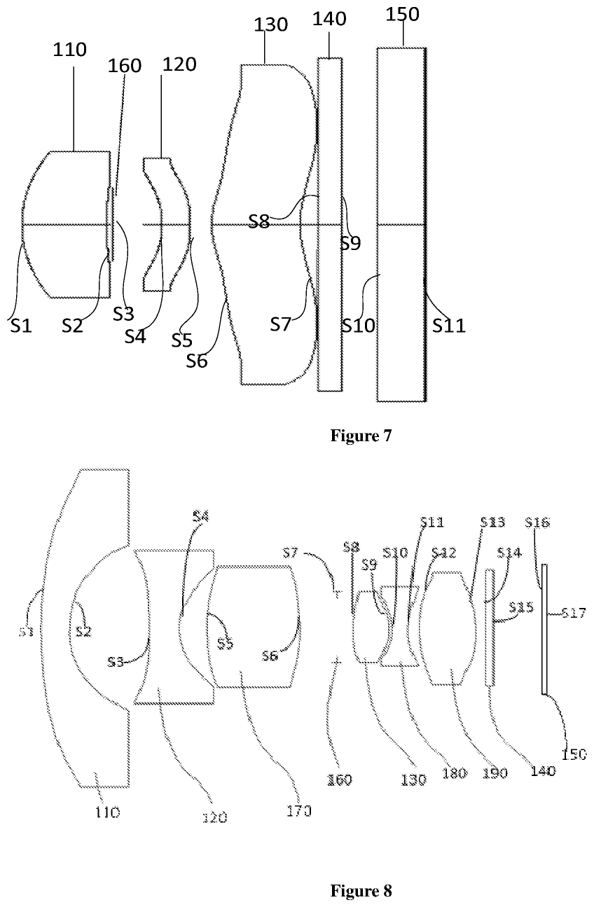

The specific structure of the glass-plastic hybrid lens assembly provided in this example can be referred to FIG. 7.

The glass-plastic hybrid lens assembly comprises a glass lens 110, a diaphragm 160, a first plastic lens 120, a second plastic lens 130, a filter 140 and a flat glass 150 from an object side to an image side of the glass-plastic hybrid lens assembly in turn. The glass lens is a spherical glass lens. The first plastic lens and the second plastic lens each are an aspheric lens, and each aspheric surface of the first plastic lens and the second plastic lens meets the following formula:

$$z = \frac{{ch}^{2}}{1 + \sqrt{1 - ( 1 + k ) {c}^{2} {h}^{2}}} + {Bh}^{4} + {Ch}^{6} + {Dh}^{8} + {Eh}^{10} + {Fh}^{12} + {Gh}^{14} + {Hh}^{16} ,$$

in which, [symbol] represents a distance between a surface and a tangent plane of a vertex of the surface in a direction of the optical axis, c represents a curvature of the vertex of the surface, k represents a 2^{nd} order correction coefficient, h represents a height from the surface to the optical axis, and B, C, D, E, F, G and H represent 4^{th}, 6^{th}, 8^{th}, 10^{th}, 12^{th}, 14^{th} and 16^{th} order correction coefficients, respectively.

The glass material selected for the glass lens 110 has an ultraviolet absorbing function, specifically dense barium flint glass having a refractive index of 1.72, with a code of H-ZBaF21. The relevant parameters of respective lenses of the glass-plastic hybrid lens assembly in this example are shown in Table 1.

TABLE 1

| Sur- | | | | | Re- | |
|---|---|---|---|---|---|---|
| face | | Surface | Curvature | Thick- | fractive | Abbe |
| No. | | type | radius | ness | index | number |
| S1 | Glass lens | Spherical | 1.4899 | 1.620 | 1.72 | 38.0 |
| S2 | | Spherical | 3.9995 | 0.0515 | | |
| S3 | Diaphragm | Spherical | — | 0.4206 | | |
| S4 | First plastic | Aspheric | −1.3128 | 0.2376 | 1.64 | 23.5 |
| S5 | lens | Aspheric | −3.3130 | 0.1816 | | |
| S6 | Second | Aspheric | 0.8963 | 0.7535 | 1.54 | 56.0 |
| S7 | plastic lens | Aspheric | 1.5525 | 0.15 | | |
| S8 | Filter | Spherical | — | 0.21 | 1.517 | 64.21 |
| S9 | | Spherical | — | 0.3 | | |
| S10 | Flat glass | Spherical | — | 0.40 | 1.517 | 64.21 |
| S11 | | Spherical | — | 0.0116 | | |

The aspheric parameters of the first plastic lens and the second plastic lens in this example are shown in Table 2.

TABLE 2

| Surface | | | | | | | | |
|---|---|---|---|---|---|---|---|---|
| No. | k | B | C | D | E | F | G | H |
| S4 | −2.16531E+01 | −1.88651E+00 | 6.60306E+00 | −7.23126E+00 | −5.92606E+01 | 3.65598E+02 | −7.95655E+02 | 6.11173E+02 |
| S5 | 1.24771E+01 | −2.04276E+00 | 8.55440E+00 | −2.72939E+01 | 6.71299E+01 | −9.47710E+01 | 6.87957E+01 | −2.07943E+01 |
| S6 | −7.80560E+00 | −4.61797E−01 | 6.98024E−01 | −5.72985E−01 | 2.86625E−01 | −8.25662E−02 | 1.15584E−02 | −4.99862E−04 |
| S7 | −7.10281E−01 | −2.30047E−01 | −4.86494E−02 | 1.98532E−01 | −1.63085E−01 | 6.57780E−02 | −1.32431E−02 | 1.04172E−03 |

### Example 4

The glass-plastic hybrid lens assembly in this example is same as that in Example 3, except for a different material of the glass lens 110. Specifically, the glass material selected for the glass lens 110 in this example has an ultraviolet absorbing function, particularly dense flint glass having a refractive index of 1.76, with a code of H-ZF12.

The relevant parameters of respective lenses of the glass-plastic hybrid lens assembly in this example are shown in Table 3.

TABLE 3

| Sur- | | | | | Re- | |
|---|---|---|---|---|---|---|
| face | | Surface | Curvature | Thick- | fractive | Abbe |
| No. | | type | radius | ness | index | number |
| S1 | Glass lens | Spherical | 1.5585 | 0.830 | 1.76 | 26.6 |
| S2 | | Spherical | 3.6058 | 0.0352 | | |
| S3 | Diaphragm | Spherical | — | 0.4443 | | |
| S4 | First plastic | Aspheric | −1.1886 | 0.2376 | 1.64 | 22.4 |
| S5 | lens | Aspheric | −2.4591 | 0.1840 | | |
| S6 | Second | Aspheric | 0.8836 | 0.8144 | 1.54 | 56.0 |
| S7 | plastic lens | Aspheric | 1.5878 | 0.15 | | |
| S8 | Filter | Spherical | — | 0.21 | 1.517 | 64.21 |
| S9 | | Spherical | — | 0.3 | | |
| S10 | Flat glass | Spherical | — | 0.40 | 1.517 | 64.21 |
| S11 | | Spherical | — | 0.0250 | | |

The aspheric parameters of the first plastic lens and the second plastic lens in this example are shown in Table 4.

TABLE 4

| Surface | | | | | | | | |
|---|---|---|---|---|---|---|---|---|
| No. | k | B | C | D | E | F | G | H |
| S4 | −19.27848 | −1.8259308 | 5.855837 | −10.351692 | −41.177431 | 431.97692 | −1239.3129 | 1198.1174 |
| S5 | −3.677469 | −1.9899842 | 8.2676727 | −30.240075 | 81.532543 | −118.04768 | 77.193508 | −13.314512 |
| S6 | −8.495849 | −0.34278699 | 0.60395028 | −0.54303991 | 0.29555177 | −0.09153089 | 0.012084941 | −5.1896807e−5 |
| S7 | −0.5993519 | −0.2713965 | 0.079296303 | 0.049342204 | −0.084578096 | 0.052660634 | −0.016114871 | 0.0018930533 |

### Example 5

The glass-plastic hybrid lens assembly in this example is same as that in Example 3, except for a different material of the glass lens 110. Specifically, the glass material selected for the glass lens 110 in this example has an ultraviolet absorbing function, particularly lanthanum flint glass having a refractive index of 1.75, with a code of H-LaF4.

The relevant parameters of respective lenses of the glass-plastic hybrid lens assembly in this example are shown in Table 5.

TABLE 5

| Sur- | | | | | Re- | |
|---|---|---|---|---|---|---|
| face | | Surface | Curvature | Thick- | fractive | Abbe |
| No. | | type | radius | ness | index | number |
| S1 | Glass lens | Spherical | 1.5300 | 1.125 | 1.75 | 35.0 |
| S2 | | Spherical | 3.8373 | 0.0527 | | |
| S3 | Diaphragm | Spherical | — | 0.4477 | | |
| S4 | First plastic | Aspheric | −1.2684 | 0.2376 | 1.64 | 23.5 |
| S5 | lens | Aspheric | −3.0930 | 0.1640 | | |
| S6 | Second | Aspheric | 0.8960 | 0.7677 | 1.54 | 56.0 |
| S7 | plastic lens | Aspheric | 1.6452 | 0.10 | | |
| S8 | Filter | Spherical | — | 0.21 | 1.517 | 64.21 |
| S9 | | Spherical | — | 0.3 | | |
| S10 | Flat glass | Spherical | — | 0.40 | 1.517 | 64.21 |
| S11 | | Spherical | — | 0.05 | | |

The aspheric parameters of the first plastic lens and the second plastic lens in this example are shown in Table 6.

TABLE 6

| Surface | | | | | | | | |
|---|---|---|---|---|---|---|---|---|
| No. | k | B | C | D | E | F | G | H |
| S4 | −29.009 | −1.9408512 | 6.435917 | −7.3820308 | −58.675887 | 368.24467 | −797.59804 | 607.9106 |
| S5 | 10.23218 | −1.9789931 | 8.2798476 | −27.635222 | 68.356764 | −95.369484 | 69.341942 | −21.624713 |
| S6 | −9.137253 | −0.41858722 | 0.66594924 | −0.56507767 | 0.28762651 | −0.082866959 | 0.011239109 | −0.00040886445 |
| S7 | −0.2451062 | −0.23026937 | −0.043287576 | 0.19248169 | −0.1621205 | 0.065392819 | −0.013061426 | 0.001006205 |

### Example 6

The schematic structure of the glass-plastic hybrid lens assembly provided in this example can be referred to FIG. 8. The glass-plastic hybrid lens assembly in this example comprises six lenses. Specifically, the glass-plastic hybrid lens assembly comprises a first glass lens 110 (made of a UV-absorbing glass material), a first plastic lens 120, a second glass lens 170, a diaphragm 160, a second plastic lens 130, a third plastic lens 180, a fourth plastic lens 190, a filter 140 and a flat glass 150 from an object side to an image side of the glass-plastic hybrid lens assembly in turn. The first glass lens 110 and the second glass lens 170 each are a spherical glass lens. The first plastic lens 120, the second plastic lens 130, the third plastic lens 180 and the fourth plastic lens 190 each are an aspheric plastic lens. The glass material selected for the glass lens 110 has an ultraviolet absorbing function, particularly dense lanthanum flint glass having a refractive index of 1.91, with a code of H-ZLaF4LA. The relevant parameters of respective lenses of the glass-plastic hybrid lens assembly in this example are shown in Table 7.

TABLE 7

| Sur- | | | | | Re- | |
|---|---|---|---|---|---|---|
| face | | Surface | Curvature | Thick- | fractive | Abbe |
| No. | | type | radius | ness | index | number |
| S1 | First glass | Spherical | 11.986 | 1.280 | 1.91 | 35.3 |
| S2 | lens | Spherical | 3.042 | 2.734 | | |
| S3 | First | Aspheric | −40.100 | 1.082 | 1.54 | 56.0 |
| S4 | plastic | Aspheric | 1.604 | 0.956 | | |
| | lens | | | | | |
| S5 | Second | Spherical | 5.718 | 3.236 | 1.91 | 35.3 |
| S6 | glass lens | Spherical | −5.718 | 1.594 | | |
| S7 | Diaphragm | | — | 0.274 | | |
| S8 | Second | Aspheric | 3.094 | 1.211 | 1.54 | 56.0 |
| S9 | plastic | Aspheric | −1.724 | 0.088 | | |
| | lens | | | | | |
| S10 | Third | Aspheric | −2.624 | 0.626 | 1.64 | 23.5 |
| S11 | plastic | Aspheric | 2.082 | 0.353 | | |
| | lens | | | | | |
| S12 | Fourth | Aspheric | 3.384 | 2.015 | 1.54 | 56.0 |
| S13 | plastic | Aspheric | −2.463 | 0.30 | | |
| | lens | | | | | |
| S14 | Filter | Spherical | — | 0.30 | 1.517 | 64.21 |
| S15 | | Spherical | — | 0.70 | | |
| S16 | Flat glass | Spherical | — | 0.40 | 1.517 | 64.21 |
| S17 | | Spherical | — | 0.20 | | |

The aspheric parameters of the first plastic lens, the second plastic lens, the third plastic lens and the fourth plastic lens in this example are shown in Table 8.

TABLE 8

| Surface | | | | | | | | |
|---|---|---|---|---|---|---|---|---|
| No. | K | B | C | D | E | F | G | H |
| S3 | 200.00 | −0.017 | 2.390e−3 | −1.821e−4 | 5.258e−6 | 1.676e−7 | 0 | 0 |
| S4 | −0.684 | −0.029 | 4.171e−3 | −4.090e−4 | −1.021e−5 | −2.505e−6 | 0 | 0 |
| S8 | 3.619 | −0.019 | 0.011 | −0.042 | 0.032 | −0.01 | 0 | 0 |
| S9 | −1.359 | 0.011 | 0.034 | −0.040 | 8.678e−3 | 1.470e−3 | 0 | 0 |
| S10 | −0.381 | −0.091 | 0.151 | −0.113 | 0.034 | −1.020e−3 | 0 | 0 |
| S11 | −6.468 | −0.019 | 0.047 | −0.026 | 6.275e−3 | −5.376e−4 | 0 | 0 |
| S12 | 0.749 | −4.818e−3 | −6.430e−3 | 4.163e−3 | −1.100e−3 | 1.041e−4 | 0 | 0 |
| S13 | −5.868 | −0.017 | 8.221e−3 | −3.472e−3 | 9.093e−4 | −8.261e−5 | 0 | 0 |

The light transmittance of the glass lens in the glass-plastic hybrid lens assembly in Examples 3-6 is shown in Table 9.

TABLE 9

| Wavelength | Light transmittance of glass lens | | | |
|---|---|---|---|---|
| (nm) | Example 3 | Example 4 | Example 5 | Example 6 |
| 2400 | 0.978 | 0.992 | 0.981 | 0.979 |
| 2200 | 0.999 | 0.994 | 0.991 | 0.994 |
| 2000 | 0.996 | 0.997 | 0.997 | 0.997 |
| 1800 | 0.998 | 0.999 | 0.998 | 0.999 |
| 1600 | 0.999 | 0.999 | 0.999 | 0.999 |
| 1400 | 0.999 | 0.999 | 0.999 | 0.999 |
| 1200 | 0.999 | 0.999 | 0.999 | 0.999 |
| 1060 | 0.999 | 0.999 | 0.999 | 0.999 |
| 1000 | 0.999 | 0.999 | 0.999 | 0.999 |
| 950 | 0.999 | 0.999 | 0.999 | 0.999 |
| 900 | 0.999 | 0.999 | 0.999 | 0.999 |
| 850 | 0.999 | 0.999 | 0.999 | 0.999 |
| 800 | 0.999 | 0.999 | 0.999 | 0.999 |
| 700 | 0.999 | 0.999 | 0.999 | 0.999 |
| 650 | 0.999 | 0.999 | 0.999 | 0.999 |
| 600 | 0.999 | 0.999 | 0.999 | 0.999 |
| 550 | 0.999 | 0.999 | 0.999 | 0.998 |
| 500 | 0.998 | 0.999 | 0.999 | 0.997 |
| 480 | 0.997 | 0.998 | 0.998 | 0.995 |
| 460 | 0.996 | 0.998 | 0.997 | 0.994 |
| 440 | 0.995 | 0.997 | 0.996 | 0.990 |
| 420 | 0.993 | 0.994 | 0.994 | 0.986 |
| 400 | 0.988 | 0.984 | 0.988 | 0.975 |
| 390 | 0.980 | 0.968 | 0.981 | 0.964 |
| 380 | 0.963 | 0.924 | 0.964 | 0.942 |
| 370 | 0.772 | 0.800 | 0.920 | 0.899 |
| 360 | 0.800 | — | 0.800 | 0.800 |
| 350 | 0.530 | — | — | — |
| 340 | — | — | — | — |
| 330 | — | — | — | — |
| 320 | — | — | — | — |
| 310 | — | — | — | — |
| 300 | — | — | — | — |
| 290 | — | — | — | — |
| 280 | — | — | — | — |

Note:
“—” means that light transmittance of material is zero at the wavelength corresponding to “—”

It can be seen from Table 9 that each lens in Examples 3-6 has a cooperated refractive index and Abbe number, thus effectively achieving athermalization, such that the glass-plastic hybrid lens assembly has high imaging quality, and has a prolonged service life due to the effective prevention of ultraviolet irradiation to subsequent plastic lenses. The minimum average thickness and the light transmittance of the glass lens meet that the glass lens has an average thickness of at least 0.8 mm when its light transmittance at a wavelength of 360 nm is 20% above.

### Example 7

The glass-plastic hybrid lens assembly in this example is same as that in Example 3, except for a different material of the glass lens 110. Specifically, the glass material selected for the glass lens 110 in this example has a function of absorbing ultraviolet rays and partial blue lights, particularly dense flint glass having a refractive index of 1.95, with a code of H-ZF88. This glass material having extremely-high refractive index and high dispersion brings great freedom to the optical design.

The relevant parameters of respective lenses of the glass-plastic hybrid lens assembly in this example are shown in Table 10.

TABLE 10

| Sur- | | | | | Re- | |
|---|---|---|---|---|---|---|
| face | | Surface | Curvature | Thick- | fractive | Abbe |
| No. | | type | radius | ness | index | number |
| S1 | Glass lens | Spherical | 1.4952 | 0.6405 | 1.95 | 17.9 |
| S2 | | Spherical | 1.8617 | 0.0484 | | |
| S3 | Diaphragm | Spherical | — | 0.3115 | | |
| S4 | First | Aspheric | −2.0361 | 0.497 | 1.64 | 23.1 |
| S5 | plastic lens | Aspheric | −46.4910 | 0.1189 | | |
| S6 | Second | Aspheric | 0.8476 | 1.0113 | 1.54 | 56.0 |
| S7 | plastic lens | Aspheric | 3.9102 | 0.1500 | | |
| S8 | Filter | Spherical | — | 0.21 | 1.517 | 64.21 |
| S9 | | Spherical | — | 0.3 | | |
| S10 | Flat glass | Spherical | — | 0.40 | 1.517 | 64.21 |
| S11 | | Spherical | — | 0.06 | | |

The aspheric parameters of the first plastic lens and the second plastic lens in this example are shown in Table 11.

TABLE 11

| Surface | | | | | | | | |
|---|---|---|---|---|---|---|---|---|
| No. | k | B | C | D | E | F | G | H |
| S4 | −114.7691 | −2.0294 | 11.2502 | −50.8716 | 90.3321 | 359.5615 | −1877.9676 | 2294.3660 |
| S5 | 4167.4749 | −2.5439 | 11.7602 | −42.6445 | 96.5322 | −93.5328 | −14.7969 | 60.5994 |
| S6 | −11.1779 | −0.2221 | 0.5128 | −0.5096 | 0.3000 | −0.1029 | 0.0178 | −1.059e−3 |
| S7 | 4.0984 | −0.0310 | −0.1294 | 0.1185 | −0.0793 | 0.0483 | −0.0175 | 2.4247e−3 |

### Example 8

The glass-plastic hybrid lens assembly in this example is same as that in Example 3, except for a different material of the glass lens 110. Specifically, the glass material selected for the glass lens 110 in this example has a function of absorbing ultraviolet rays and partial blue lights, particularly dense flint glass having a refractive index of 2.00, with a code of D-ZF93. This glass material having extremely-high refractive index and high dispersion brings great freedom to the optical design.

The relevant parameters of respective lenses of the glass-plastic hybrid lens assembly in this example are shown in Table 12.

TABLE 12

| Sur- | | | | | Re- | |
|---|---|---|---|---|---|---|
| face | | Surface | Curvature | Thick- | fractive | Abbe |
| No. | | type | radius | ness | index | number |
| S1 | Glass lens | Spherical | 1.5238 | 0.6363 | 2.00 | 20.7 |
| S2 | | Spherical | 1.9184 | 0.0491 | | |
| S3 | Diaphragm | Spherical | — | 0.3056 | | |
| S4 | First | Aspheric | −2.0192 | 0.2493 | 1.64 | 23.1 |
| S5 | plastic lens | Aspheric | −30.2148 | 0.1145 | | |
| S6 | Second | Aspheric | 0.8817 | 1.0490 | 1.54 | 56.0 |
| S7 | plastic lens | Aspheric | 4.0312 | 0.15 | | |
| S8 | Filter | Spherical | — | 0.21 | 1.517 | 64.21 |
| S9 | | Spherical | — | 0.3 | | |
| S10 | Flat glass | Spherical | — | 0.40 | 1.517 | 64.21 |
| S11 | | Spherical | — | 0.04 | | |

The aspheric parameters of the first plastic lens and the second plastic lens in this example are shown in Table 13.

TABLE 13

| Surface | | | | | | | | |
|---|---|---|---|---|---|---|---|---|
| No. | k | B | C | D | E | F | G | H |
| S4 | −83.4822 | −1.7447 | 8.8090 | −36.6262 | 57.6981 | 328.6302 | −1593.3409 | 1904.9950 |
| S5 | 1729.5697 | −2.4380 | 11.5839 | −41.8529 | 95.4685 | −92.4590 | −17.4667 | 62.8075 |
| S6 | −12.3346 | −0.2167 | 0.5188 | −0.5243 | 0.3044 | −0.0986 | 0.0146 | −4.734e−4 |
| S7 | 3.8100 | −0.0314 | −0.1141 | 0.1075 | −0.0795 | 0.0491 | −0.0173 | 2.3031e−3 |

The light transmittance listing of the glass material selected for the glass lens of the glass-plastic hybrid lens assembly in Examples 7 and 8 can be referred to Table 14.

TABLE 14
Light transmittance of glass lens
(Sample thickness: 5 mm)

| Wavelength (nm) | Example 7 | Example 8 |
|---|---|---|
| 2400 | 0.973 | 0.854 |
| 2200 | 0.983 | 0.947 |
| 2000 | 0.993 | 0.981 |
| 1800 | 0.996 | 0.992 |
| 1600 | 0.998 | 0.997 |
| 1400 | 0.999 | 0.998 |
| 1200 | 0.999 | 0.999 |
| 1060 | 0.999 | 0.999 |
| 1000 | 0.999 | 0.998 |
| 950 | 0.998 | 0.998 |
| 900 | 0.998 | 0.998 |
| 850 | 0.997 | 0.997 |
| 800 | 0.997 | 0.995 |
| 700 | 0.996 | 0.994 |
| 650 | 0.995 | 0.993 |
| 600 | 0.994 | 0.993 |
| 550 | 0.989 | 0.988 |
| 500 | 0.973 | 0.958 |
| 480 | 0.960 | 0.927 |
| 460 | 0.941 | 0.869 |
| 440 | 0.908 | 0.758 |
| 420 | 0.837 | 0.530 |
| 400 | 0.486 | 0.134 |
| 390 | 0.158 | — |
| 380 | — | — |
| 370 | — | — |
| 360 | — | — |
| 350 | — | — |
| 340 | — | — |
| 330 | — | — |
| 320 | — | — |
| 310 | — | — |
| 300 | — | — |
| 290 | — | — |
| 280 | — | — |

Note:
“—” means that light transmittance of material is zero at the wavelength corresponding to “—”

Each lens in Examples 7 and 8 has a cooperated refractive index and Abbe number, thus effectively achieving athermalization, such that the glass-plastic hybrid lens assembly has high imaging quality, and has an effectively prolonged service life because the glass lens having a function of absorbing ultraviolet rays and partial blue lights can effectively prevent ultraviolet irradiation to subsequent plastic lenses and reduce damage of blue lights to the subsequent plastic lenses.

### Example 9

The glass-plastic hybrid lens assembly in this example is same as that in Example 3, except that an ultraviolet-infrared cutoff film is disposed at the surface of the glass lens facing the object side, an anti-reflection film is disposed at the surface of the glass lens facing the image side, a waterproof film is disposed at the surface of the ultraviolet-infrared cutoff film close to the object side, and the glass lens has a function of absorbing ultraviolet rays, particularly dense flint glass, with a code of H-ZF12.

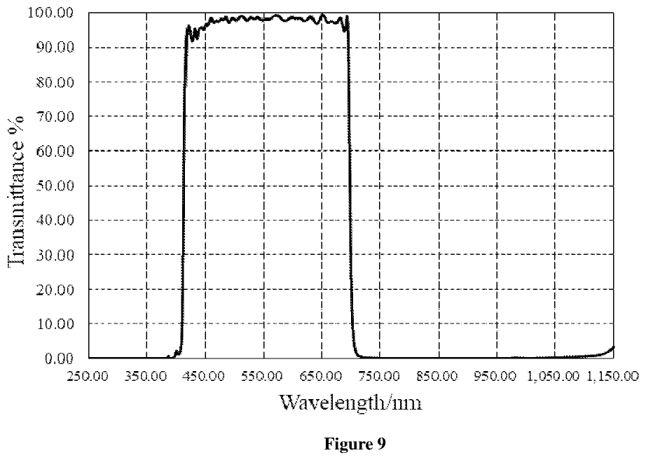

As shown in the transmittance curves of FIG. 9, the glass-plastic hybrid lens assembly provided in this example has light transmittance at visible-light waveband from 410 nm to700 nm of 96% above, and shows nearly transmittance cut-off to both the ultraviolet waveband from 250 nm to 400 nm and the near-infrared waveband from 700 nm to 1100 nm.

According to the description of the present disclosure, it is to be understood that the terms “first” and “second” are used for descriptive purposes only, which are not to be construed as indicating or implying a relative importance or implicitly indicating the number of indicated technical features. Thus, the features defining “first” and “second” may explicitly or implicitly include one or more of the features. According to the description of the present disclosure, the term “a plurality of” means two or more than two, unless specifically defined otherwise.

According to the description of the present specification, the description with reference to the terms “one embodiment”, “some embodiments”, “an example”, “a specific example” or “some examples” and the like means specific features, structures, materials or characteristics described in connection with the embodiment or example are included in at least one embodiment or example of the present disclosure. In the present specification, the schematic representation of the above terms is not necessarily directed to the same embodiment or example. Further, the specific features, structures, materials, or characteristics described may be combined in any one or a plurality of embodiments or examples in a suitable manner. In addition, various embodiments or examples as well as features of various embodiments or examples described in the specification may be combined by skilled in the art without inconsistency.

Although the embodiments of the present disclosure have been shown and described, it is understood that the embodiments as described above are illustrative and are not to be construed as limiting the present disclosure. The embodiments are subject to variations, modifications, substitutions and variations. Changes, modifications, alterations and variations of the embodiments as described above can be made by skilled in the art within the scope of the present disclosure.

1. A glass-plastic hybrid lens assembly comprising:
a glass lens and at least one plastic lens from an object side to an image side of the glass-plastic hybrid lens assembly in turn, and
an ultraviolet cutoff layer,
wherein the ultraviolet cutoff layer is disposed at a side of the plastic lens away from the image side, and the ultraviolet cutoff layer is disposed spaced from the plastic lens.

2. The glass-plastic hybrid lens assembly according to claim 1, wherein the glass lens is made of a material capable of absorbing ultraviolet ray, and the glass lens is multiplexed into the ultraviolet cutoff layer.

3. The glass-plastic hybrid lens assembly according to claim 1, wherein the ultraviolet cutoff layer is disposed at a first surface of the glass lens facing the object side or disposed at a second surface of the glass lens facing the image side.

4. The glass-plastic hybrid lens assembly according to claim 1, wherein the glass-plastic hybrid lens assembly further comprises an anti-reflection firm,
wherein the anti-reflection firm is disposed at a first surface of the glass lens facing the object side or disposed at a second surface of the glass lens facing the image side.

5. The glass-plastic hybrid lens assembly according to claim 4, wherein one of the ultraviolet cutoff layer and the anti-reflection film is disposed at the first surface of the glass lens facing the object side, and the other of the ultraviolet cutoff layer and the anti-reflection film is disposed at the second surface of the glass lens facing the image side.

6. The glass-plastic hybrid lens assembly according to claim 1, wherein the ultraviolet cutoff layer is selected from an ultraviolet cutoff film and an ultraviolet-infrared cutoff film.

7. The glass-plastic hybrid lens assembly according to claim 6, wherein the ultraviolet cutoff film or the ultraviolet-infrared cutoff film has an anti-reflection effect on visible lights.

8. The glass-plastic hybrid lens assembly according to claim 2, wherein the glass lens has an average thickness not less than 0.8 mm and has a light absorption at a wavelength of 360 nm not less than 20%.

9. The glass-plastic hybrid lens assembly according to claim 2, wherein the material forming the glass lens is flint glass.

10. The glass-plastic hybrid lens assembly according to claim 2, wherein the glass lens is capable of absorbing both ultraviolet rays and lights at a wavelength between 400 nm and 500 nm.

11. The glass-plastic hybrid lens assembly according to claim 1, wherein the glass lens is a spherical glass lens or a flat glass lens.

12. The glass-plastic hybrid lens assembly according to claim 1, wherein the glass lens is an aspheric glass lens.

13. The glass-plastic hybrid lens assembly according to claim 1, wherein the glass-plastic hybrid lens assembly further comprises a waterproof film, an anti-scratch film or a waterproof-antiscratch film,
wherein the waterproof film, the anti-scratch film or the waterproof-antiscratch film is disposed at a side of the glass lens close to the object side and is disposed close to an object.

14. The glass-plastic hybrid lens assembly according to claim 1, wherein the glass-plastic hybrid lens assembly further comprises a lens barrel, and
wherein the glass lens, the plastic lens and the ultraviolet cutoff layer are all disposed in the lens barrel, and at least a portion of the outer surface of the lens barrel is provided with an ultraviolet reflective film or an ultraviolet absorbing film.

15. The glass-plastic hybrid lens assembly according to claim 1, wherein the glass-plastic hybrid lens assembly is a vehicle-mounted lens.

16. A vehicle, comprising a glass-plastic hybrid lens assembly, wherein the glass-plastic hybrid lens assembly comprises:
a glass lens and at least one plastic lens from an object side to an image side of the glass-plastic hybrid lens assembly in turn, and
an ultraviolet cutoff layer,
wherein the ultraviolet cutoff layer is disposed at a side of the plastic lens away from the image side, and the ultraviolet cutoff layer is disposed spaced from the plastic lens.

17. The vehicle according to claim 16, wherein the glass lens is made of a material capable of absorbing ultraviolet ray, and the glass lens is multiplexed into the ultraviolet cutoff layer.

18. The vehicle according to claim 16, wherein the ultraviolet cutoff layer is disposed at a first surface of the glass lens facing the object side or disposed at a second surface of the glass lens facing the image side.

19. The vehicle according to claim 16, wherein the glass-plastic hybrid lens assembly further comprises an anti-reflection firm,
wherein the anti-reflection firm is disposed at a first surface of the glass lens facing the object side or disposed at a second surface of the glass lens facing the image side.

20. The glass-plastic hybrid lens assembly according to claim 9, wherein the glass lens is capable of absorbing both ultraviolet rays and lights at a wavelength between 400 nm and 500 nm.
